(19) United States
(12) Patent Application Publication
(10) Pub. No.: US 2024/0337437 A1
(43) Pub. Date: Oct. 10, 2024

(54) REFRIGERATOR AND CONTROL METHOD THEREFOR

(71) Applicant: SAMSUNG ELECTRONICS CO., LTD., Suwon-si Gyeonggi-do (KR)

(72) Inventors: Deulre MIN, Suwon-si (KR); Seokjun SON, Suwon-si (KR); Heecheol KANG, Suwon-si (KR)

(73) Assignee: SAMSUNG ELECTRONICS CO., LTD., Suwon-si Gyeonggi-do (KR)

(21) Appl. No.: 18/749,186

(22) Filed: Jun. 20, 2024

Related U.S. Application Data
(63) Continuation of application No. PCT/KR2022/016339, filed on Oct. 25, 2022.

(30) Foreign Application Priority Data
Dec. 23, 2021 (KR) 10-2021-0186341

(51) Int. Cl. F25D 31/00; A47J 39/00; F25D 11/02; F25D 29/00

(52) U.S. Cl. CPC F25D 31/005; A47J 39/003; F25D 11/02; F25D 29/00; F25D 2400/02; F25D 2600/06

(57) ABSTRACT

A refrigerator including a main body; a control panel arranged on one surface of the main body; a storage compartment arranged in the main body; a case arranged in the storage compartment; a heater arranged in the case; a fan configured to introduce air from outside the case into the case; and a processor configured to control the heater to maintain a temperature in the case at a fermentation temperature for a fermentation time. The processor may control the heater to maintain a temperature in the case at a first temperature for a first time period based on receiving a user input for a normal fermentation from the control panel, and control the heater to maintain the temperature in the case at a second temperature higher than the first temperature for a second time period shorter than the first time period, based on receiving a user input for a rapid fermentation from the control panel.

### CROSS-REFERENCE TO RELATED APPLICATION

This application is a continuation application, under 35 U.S.C. § 111(a), of international application No. PCT/KR2022/016339, filed on Oct. 25, 2022, which claims priority under 35 U. S. C. § 119 to Korean Patent Application No. 10-2021-0186341, filed Dec. 23, 2021, the disclosures of which are incorporated herein by reference in their entireties.

### BACKGROUND

### Technical Field

The disclosure relates to a refrigerator including a fermenter and a method for controlling the same.

### Description of the Related Art

In general, a refrigerator cools the air in a storage compartment using a refrigerant cycle including compression, condensation, expansion, and evaporation. A refrigerator may keep food fresh for a long period of time by supplying the air cooled around an evaporator where refrigerant evaporates to a storage compartment. The storage compartment is divided into a refrigerating compartment maintained at approximately 3° C. to store food in a refrigerated manner and a freezing compartment maintained at approximately −20° C. to store food in a frozen manner.

Recently, fermented foods have been widely known to be good for health, and interest in fermented foods has increased.

Accordingly, the amount of fermented foods consumed is increasing. Also, various types of fermented foods are traditionally consumed in some countries or regions.

Fermented foods are generally fermented at or above room temperature and are stored at temperatures below room temperature.

A fermenter is a device for producing fermented foods, such as yogurt, cheese, pickles, yeast bread, and the like, by fermenting fermentation ingredients, vegetables, flour dough, and the like. The fermenter may ferment fermentation ingredients by heating a container containing the fermentation ingredients to room temperature or higher.

Existing fermenters are independently configured, and have only the function of producing fermented food, and thus the fermented food produced by the existing fermenter is required to be stored in a refrigerator separately, causing inconvenience.

### SUMMARY

According to an aspect of the disclosure, a refrigerator may include: a main body; a control panel arranged on one surface of the main body; a storage compartment arranged in the main body; a case arranged in the storage compartment; a heater arranged in the case; a fan configured to introduce air from outside the case into the case; and a processor configured to control the heater to maintain a temperature in the case at a fermentation temperature for a fermentation time based on receiving a user input from the control panel. The processor may be configured to control the heater based on receiving a user input for a normal fermentation through the control panel to maintain the temperature in the case at a first temperature for a first time period, and control the heater based on receiving a user input for a rapid fermentation through the control panel to maintain the temperature in the case at a second temperature higher than the first temperature for a second time period shorter than the first time period.

The processor may be configured to control the fan to introduce air in the storage compartment into the case based on the fermentation time having elapsed.

The processor may be configured to receive a user input for fermented food through the control panel; and control the heater to maintain the temperature in the case at different temperatures based on user inputs for different fermented foods.

The processor may be configured to receive a user input for fermented food from the control panel; and control the heater to maintain the temperature in the case at the fermentation temperature for different time periods based on user inputs for different fermented foods.

The processor may be configured to control the heater to maintain the temperature in the case at the first temperature based on receiving a user input for selecting a first fermentation level from the control panel; and control the heater to maintain the temperature in the case at a third temperature higher than the first temperature based on receiving a user input for selecting a second fermentation level from the control panel.

The processor may be configured to control the heater to maintain the temperature in the case at the first temperature for the first time period based on receiving a user input for selecting a first fermentation level from the control panel; and control the heater to maintain the temperature in the case at the first temperature for a third time period longer than the first time period based on receiving a user input for selecting a second fermentation level from the control panel.

The processor may be configured to control the heater to maintain the temperature in the case at the first temperature for the first time period based on receiving a user input for selecting a first fermentation level from the control panel; and control the heater to maintain the temperature in the case at a third temperature higher than the first temperature for a third time period longer than the first time period based on receiving a user input for selecting a second fermentation level from the control panel.

The processor may be configured to set at least one of the fermentation time or the fermentation temperature based on a remaining time until consumed by a user, based on receiving a user input for the remaining time until consumed by the user from the control panel.

The processor may be configured to control the heater to maintain the temperature in the case at the first temperature for a first time period, based on the remaining time until consumed by the user being greater than or equal to the first time period.

The processor may be configured to control the heater to maintain the temperature in the case at the fermentation temperature for the remaining time until consumed by the user, based on the remaining time until consumed by the user being less than the first time period.

The processor may be configured to control the heater to maintain the temperature in the case at a target temperature that depends on the remaining time until consumed by the user, based on the remaining time until consumed by the user being less than the first time period.

According to an aspect of the disclosure, a method for controlling a refrigerator including a case arranged in a storage compartment, a heater arranged in the case, and a fan configured to introduce air from outside the case into the case may include: controlling the heater to maintain a temperature in the case at a fermentation temperature for a fermentation time based on receiving a user input from a control panel of the refrigerator; and controlling the fan to introduce air in the storage compartment into the case based on the fermentation time having elapsed. The controlling of the heater may include: controlling the heater based on receiving a user input for a normal fermentation via the control panel to maintain the temperature in the case at a first temperature for a first time period; and controlling the heater based on receiving a user input for a rapid fermentation via the control panel to maintain the temperature in the case at a second temperature higher than the first temperature for a second time period shorter than the first time period

### BRIEF DESCRIPTION OF DRAWINGS

FIG. 1 is a view illustrating a refrigerator according to an embodiment.

FIG. 2 is a view illustrating a fermenter included in a refrigerator according to an embodiment.

FIG. 3 is a view illustrating a rear surface of a fermenter included in a refrigerator according to an embodiment.

FIG. 4 is a view illustrating a fermentation case and a container assembly included in a refrigerator according to an embodiment.

FIG. 5 is an exploded view of a fermenter included in a refrigerator according to an embodiment.

FIG. 6 is an exploded view of a container assembly included in a refrigerator according to an embodiment.

FIG. 7 is a control block diagram of a refrigerator according to an embodiment.

FIG. 8 illustrates a control panel of a refrigerator according to an embodiment.

FIG. 9 illustrates an example of operations for producing fermented food by a refrigerator according to an embodiment.

FIG. 10 illustrates a change in an internal temperature of a fermenter due to the operations shown in FIG. 9 according to an embodiment.

FIG. 11 illustrates an example of operations for producing fermented food by a refrigerator according to an embodiment.

FIG. 12 illustrates an example of a change in an internal temperature of a fermenter due to the operations shown in FIG. 11 according to an embodiment.

FIG. 13 illustrates another example of a change in an internal temperature of a fermenter due to the operations shown in FIG. 11 according to an embodiment.

FIG. 14 illustrates an example of operations for producing fermented food by a refrigerator according to an embodiment according to an embodiment.

FIG. 15 illustrates an example of a change in an internal temperature of a fermenter due to the operations shown in FIG. 14 according to an embodiment.

FIG. 16 illustrates an example of operations for producing fermented food by a refrigerator according to an embodiment.

FIG. 17 illustrates an example of warning that a fresh storage time of fermented food is about to expire by a refrigerator according to an embodiment.

### DETAILED DESCRIPTION

Like reference numerals throughout the specification denote like elements. Also, this specification does not describe all the elements according to embodiments of the disclosure, and descriptions well-known in the art to which the disclosure pertains or overlapped portions are omitted. The terms such as “˜part”, “˜member”, “˜module”, “˜block”, and the like may refer to at least one process processed by at least one hardware or software. According to embodiments, a plurality of “˜part”, “˜member”, “˜module”, “˜block” may be embodied as a single element, or a single of “˜part”, “˜member”, “˜module”, “˜block” may include a plurality of elements.

It will be understood that when an element is referred to as being “connected” to another element, it may be directly or indirectly connected to the other element, wherein the indirect connection includes “connection” via a wireless communication network.

It will be further understood that the term “include” when used in this specification, specifies the presence of stated elements, but do not preclude the presence or addition of one or more other elements.

It will also be understood that when a certain component is referred to as being “on” or “over” another component, it may be directly on the other component or intervening components may also be present.

The terms including ordinal numbers like “first” and “second” may be used to distinguish a corresponding component from another, but the components are not limited by the terms.

It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

An aspect of the disclosure is directed to providing a refrigerator including a fermenter that may produce various fermented foods, and a method for controlling the same.

An aspect of the disclosure is directed to providing a refrigerator that operates a compressor in response to completion of production of fermented food, and a method for controlling the same.

An aspect of the disclosure is directed to providing a refrigerator including a fermenter that may produce fermented foods with different degrees of fermentation according to a user's selection, and a method for controlling the same.

An aspect of the disclosure is directed to providing a refrigerator including a fermenter that may control a fermentation time of food to allow a user to have the fermented food at a user-specified time, and a method for controlling the same.

According to an aspect of the disclosure, a refrigerator including a fermenter that may produce various fermented foods, and a method for controlling the same may be provided. Accordingly, the refrigerator may cool fermented food immediately after production of the fermented food is completed, thereby suppressing or preventing deterioration of the fermented food.

According to an aspect of the disclosure, a refrigerator that operates a compressor in response to completion of production of fermented food, and a method for controlling the same may be provided. As such, the refrigerator may pre-cool a storage compartment including a fermenter in preparation for an increase in cooling load for cooling the fermented food. Accordingly, the refrigerator may suppress or prevent a rapid temperature increase in the storage compartment due to heated fermented food and fermentation container.

According to an aspect of the disclosure, a refrigerator including a fermenter that may produce fermented foods with different degrees of fermentation according to a user's selection, and a method for controlling the same may be provided. Accordingly, the refrigerator may provide a user with fermented foods with different degrees of fermentation based on a user's preference.

According to an aspect of the disclosure, a refrigerator including a fermenter that may control a fermentation time of food to allow a user to have the fermented food at a user-specified time, and a method for controlling the same may be provided. Accordingly, the refrigerator may quickly provide the user with the fermented food.

Hereinafter, an operation principle and embodiments will be described in detail with reference to the accompanying drawings.

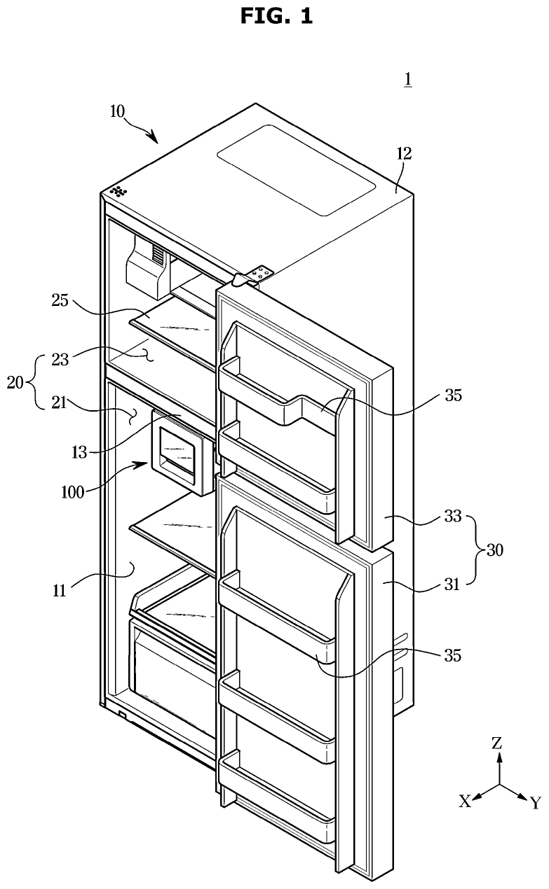

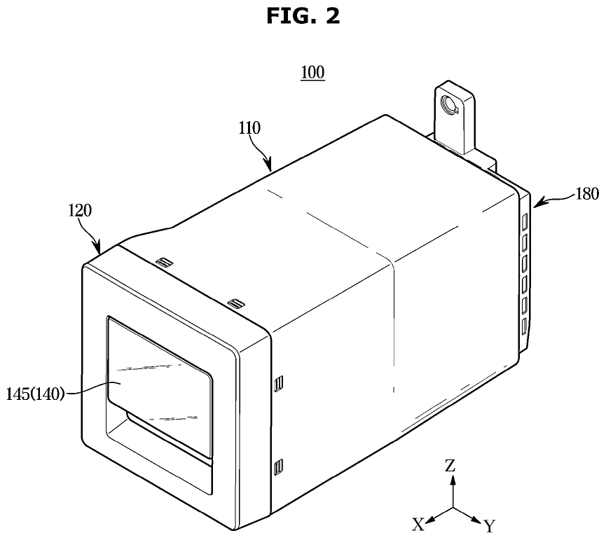

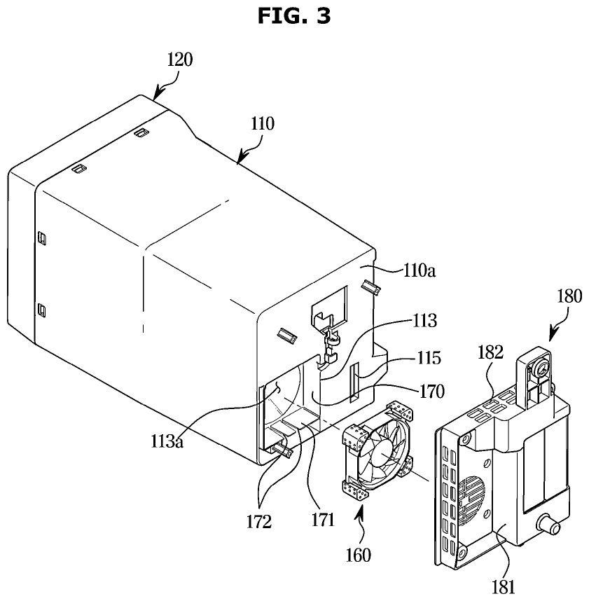

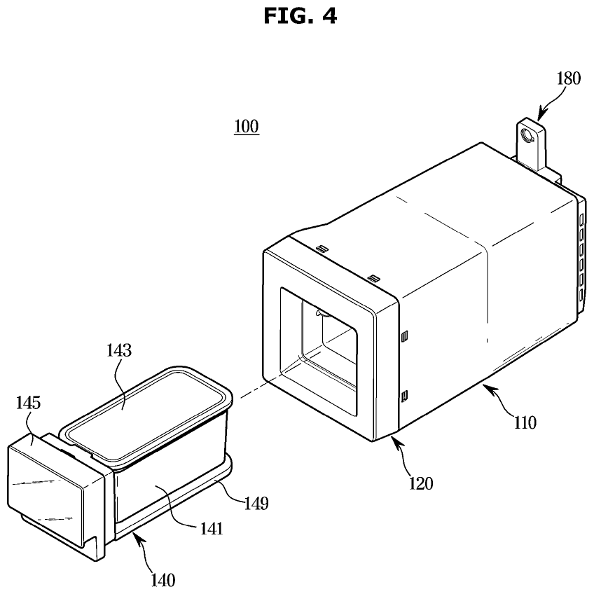

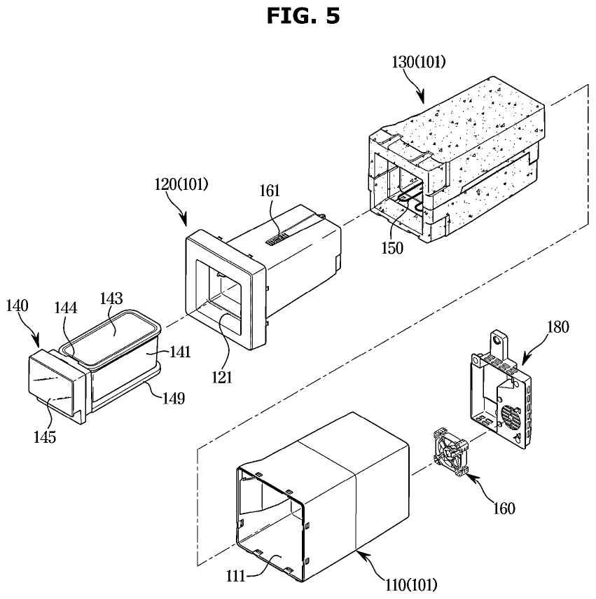

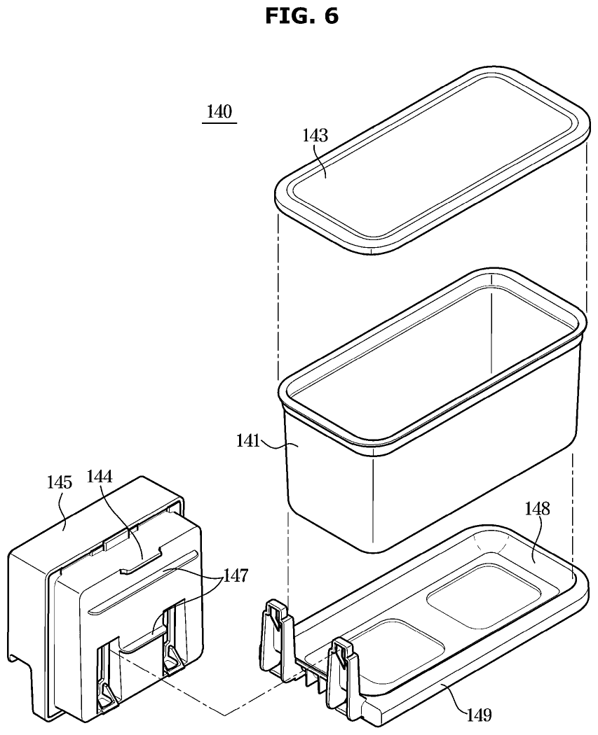

FIG. 1 is a view illustrating a refrigerator according to an embodiment. FIG. 2 is a view illustrating a fermenter included in a refrigerator according to an embodiment. FIG. 3 is a view illustrating a rear surface of a fermenter included in a refrigerator according to an embodiment. FIG. 4 is a view illustrating a fermentation case and a container assembly included in a refrigerator according to an embodiment. FIG. 5 is an exploded view of a fermenter included in a refrigerator according to an embodiment. FIG. 6 is an exploded view of a container assembly included in a refrigerator according to an embodiment.

Referring to FIG. 1, a refrigerator 1 includes a main body 10, a storage compartment 20 disposed in the main body 10 and having a front side configured be opened, and a door 30 rotatably coupled to the main body 10 to open and close the open front of the storage compartment 20.

The main body 10 includes an inner case 11 that forms the storage compartment 20, an outer case that forms an exterior, and a cooling device that supplies cooled air to the storage compartment 20.

The cooling device may include a compressor, a condenser, an expansion valve, an evaporator, and the like, and an insulating material is arranged between the inner case 11 and the outer case of the main body 10 to prevent cooled air from leaking out of the storage compartment 20.

The storage compartment 20 may be divided into a refrigerating compartment 21 and a freezing compartment 23 by a partition wall 13. A plurality of shelves 25 may be arranged in the storage compartment 20 to divide the refrigerating compartment 21 and the freezing compartment 23 into a plurality of compartments.

The refrigerating compartment 21 and the freezing compartment 23 may be opened and closed by a refrigerating compartment door 31 and a freezing compartment door 33, and may be rotatably coupled to the main body 10, respectively. A plurality of door guards 35 may be installed on a rear surface of the door 30 to store food, and the like.

Inside the refrigerating compartment 21, a fermenter 100 may be arranged to produce fermented foods, such as curd, labneh, skyr, kefir, yogurt, cheese, mango pickles, idli, dosa, naan, laban, torshi, ayran, tursu, dahi, achar, durian pickles, and the like, by fermenting fermentation ingredients.

Although the fermenter 100 is shown as being disposed inside the refrigerating compartment 21, the fermenter 100 may be accommodated in a separate, independent space within the refrigerating compartment 21.

Referring to FIG. 2, FIG. 3, FIG. 4 and FIG. 5, the fermenter 100 may include a case 101 including an outer case 110 forming an exterior, an inner case 120 arranged inside the outer case 110, and an insulating material 130 arranged between the outer case 110 and the inner case 120.

The fermenter 100 may include a fermentation container assembly 140 including a fermentation container 141 in which fermentation ingredients are stored and which is accommodated in the inner case 120.

The fermenter 100 may include a heater 150 for heating the fermentation container 141 to ferment the fermentation ingredients stored in the fermentation container 141, and a fan 160 for supplying cooled air to the fermentation container 141 to refrigerate the fermented food.

The fermenter 100 may include a temperature sensor 161 that measures an internal temperature thereof.

An opening 111 may be formed on a front surface of the outer case 110 to allow the insulating material 130 and the inner case 120 to be inserted into the outer case 110. An opening 121 may be formed on a front surface of the inner case 120 to allow the fermentation container 141 to be inserted into and withdrawn from the inner case 120.

A partition 180 may be arranged on a rear surface of the outer case 110 to space the fermenter 100 from the inner case 11.

In the partition 180, a plurality of ventilation holes 182 may be formed to introduce cooled air in the refrigerating compartment 21 through an intake port 113 formed in the case 101 of the fermenter 100 and to discharge the introduced cooled air into the refrigerating compartment 21 again through a discharge port 115 formed in the case 101 of the fermenter 100.

The partition 180 may be provided with a blocking partition 181 to prevent the cooled air discharged through the discharge port 115 from being introduced back into the intake port 113 and recirculated.

A rear wall 110a of the outer case 110 may be provided with a fan mounting portion 170 in which an inflow flow path 113a is formed to draw in the cooled air in the refrigerating compartment 21, and the fan 160 may be mounted to the fan mounting portion 170.

Specifically, the fan mounting portion 170 may be disposed on the inflow flow path 113a formed inside the fan mounting portion 170. The discharge port 115 may be formed on the rear surface of the outer case 110 through which the cooled air introduced into the fermenter 100 is discharged.

The fan mounting portion 170 may have the first intake port 113 formed at one end, and the fan 160 may be mounted to the fan mounting portion 170 to allow one side of the fan 160 to communicate with the first intake port 113. One end of the inflow flow path 113a may communicate with the first intake port 113.

The fan 160 may be mounted by being inserted into the fan mounting portion 170 that is concavely formed as a part of the rear wall 110a of the outer case 110.

The fan mounting portion 170 may include a fan lower mounting wall 171 that forms a lower surface of the fan mounting portion 170. The fan lower mounting wall 171 may be formed to protrude from the rear surface of the outer case 110 and may form a portion of the first intake port 113. Specifically, the fan lower mounting wall 171 may be arranged at a lower end of an outer surface of the rear wall 110a and may be formed as a plate-shaped rib extending in the horizontal direction.

One end of the fan lower mounting wall 171 may correspond to a portion of the first intake port 113. Because the fan lower mounting wall 171 forms the lower surface of the fan mounting portion 170, the fan lower mounting wall 171 may support the fan 160 below the fan 160.

A drain slit 172 may be formed on the fan lower mounting wall 171. Specifically, the fan lower mounting wall 171 may extend in the horizontal direction, and the drain slit 172 may be formed to penetrate the fan lower mounting wall 171. In other words, a space above an upper surface of the fan lower mounting wall 171 and a space below a lower surface of the fan lower mounting wall 171, which are divided based on the fan lower mounting wall 171, may be connected by the drain slit 172. Accordingly, fermentation ingredients and/or fermented food placed on the upper surface of the fan lower mounting wall 171 may be drained into the space below the lower surface of the fan lower mounting wall 171 through the drain slit 172.

The space below the lower surface of the fan lower mounting wall 171 may be connected to the outside of the fermenter 100. Even in a case where the fermentation ingredients or fermented food overflows from the fermentation container 141 and flows out to the upper surface of the fan mounting portion 170 through the inflow flow path 113a, the fermentation ingredients or fermented food may be drained to the outside of the fermenter 100 through the drain slit 172 due to gravity, slight vibration of the fan 160, and the like. Accordingly, the fermentation ingredients or fermented food overflowing from the fermentation container 141 may be suppressed or prevented from contaminating the fan 160, and also failure of the fermenter 100 due to the contamination may be suppressed or prevented.

The fermenter 100 may include the inner case 120 in which a storage space for accommodating the fermentation container 141 is formed. The storage space may be formed surrounded by a left surface, right surface, lower surface, upper surface, and rear surface of the inner case 120, and the front surface of the storage space may correspond to the opening 121.

The inner case 120 may be formed as a single piece by injection molding. In this case, there is no gap which is generated in a case where each side of the inner case 120 is manufactured separately and assembled, or the inner case 120 is manufactured by dividing into two and then assembled. Accordingly, in a case where the fermentation ingredients or fermented food overflow into the storage space, the fermentation ingredients or fermented food may be suppressed or prevented from flowing into the gap, and overflowed fermentation ingredients or fermented food may be easily removed.

Referring to FIG. 6, the fermentation container assembly 140 may include the fermentation container 141 that stores fermentation ingredients and is inserted into the storage space of the inner case 120, a cover 143 covering an open top of the fermentation container 141, a fermenter door 145 that opens and closes the opening 121 formed on the front surface of the inner case 120, and a mounting bracket 149 that is coupled to the fermenter door 145 and to which the fermentation container 141 is detachably mounted.

The fermenter door 145 may include division ribs 147 formed on a rear surface of the fermenter door 145. The division ribs 147 may divide a cooling flow path in a vertical direction to form a first flow path and a second flow path together with division ribs formed on left and right sides of the inner case 120.

The fermenter door 145 may include a separation prevention protrusion 144 formed to suppress or prevent the fermentation container 141 from being separated from the mounting bracket 149 due to shock that occurs when the fermentation container assembly 140 is inserted into and withdrawn from the storage space. The separation prevention protrusion 144 may protrude from the rear surface of the fermenter door 145.

The top of the fermentation container 141 may be open, and fermentation ingredients for producing fermented food may be stored in the fermentation container 141 and may be inserted into the fermenter 100. In order to suppress or prevent the produced fermented food from overflowing from the fermentation container 141, the cover 143 may be provided on the open top of the fermentation container 141 to seal the fermentation container 141.

The fermentation ingredients stored in the fermentation container 141 may be fermented by heating by the heater 150, thereby producing fermented food. Overfermentation of the produced fermented food may be suppressed or prevented by cooling by the fan 160, and the produced fermented food may be stored in a fresh refrigerated state.

The fermenter door 145 may open and close the opening 121 of the inner case 120 in a sliding manner, and because the fermentation container 141 is detachably mounted to the mounting bracket 149 coupled to the fermenter door 145, the fermentation container 141 may be inserted and withdrawn as the fermenter door 145 is opened and closed.

The mounting bracket 149 may include a seating portion 148 formed to surround a lower surface and lower edges of the fermentation container 141. Specifically, the lower edges of the fermentation container 141 may be rounded to have a curved surface, and the seating portion 148 of the mounting bracket 149 may have a curved surface corresponding to the curved surface of the lower edges of the fermentation container 141. When the fermentation container 141 is mounted to the mounting bracket 149, the seating portion 148 may surround the edges of the fermentation container 141 and may prevent the fermentation container 141 from leaving the mounting bracket 149.

The fermentation container 141 may be detachably coupled to the mounting bracket 149 with the cover 143 mounted thereon. Specifically, the fermentation container 141 may be mounted to be disposed in a space between the mounting bracket 149 and the separation prevention protrusion 144. The lower edges of the fermentation container 141 may be supported by the seating portion 148, and an upper end of the fermentation container 141 may be supported by the separation prevention protrusion 144. Accordingly, even in a case where an impact occurs when the fermentation container 141 is inserted into or withdrawn from the inner case 120 in a state where the fermentation container 141 is mounted to the fermentation container assembly 140, the fermentation container 141 may be suppressed or prevented from being separated from the mounting bracket 149.

In the above, the structure of the refrigerator 1 and the fermenter 100 in the refrigerator 1 has been described in detail. Hereinafter, operations of the refrigerator 1 and the fermenter 100 will be described in detail.

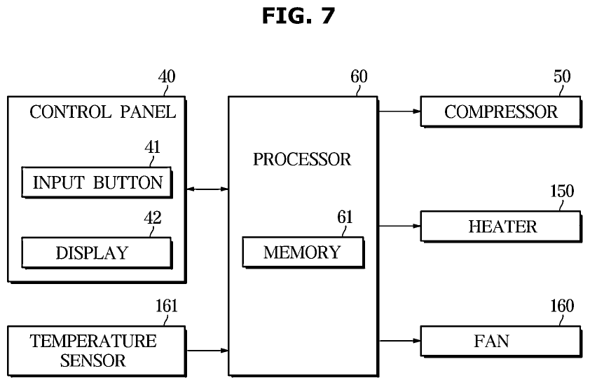

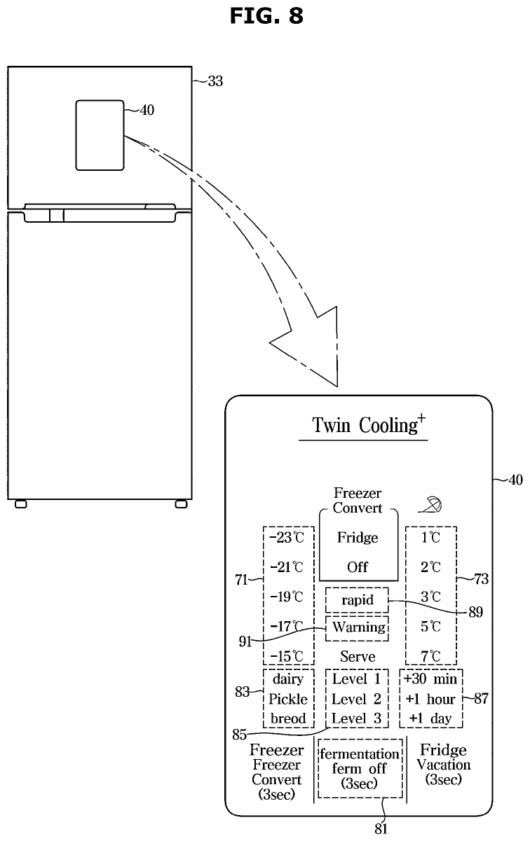

FIG. 7 is a control block diagram of a refrigerator according to an embodiment. FIG. 8 illustrates a control panel of a refrigerator according to an embodiment.

Referring to FIG. 7 and FIG. 8, the refrigerator 1 may include a control panel 40, the temperature sensor 161, a compressor 50, the heater 150, the fan 160, and/or a processor 60. A configuration of the refrigerator 1 is not limited to that shown in FIG. 7, and some of the components shown in FIG. 7 may be omitted or components not shown in FIG. 7 may be added.

The control panel 40 may provide a user with a user interface for interaction with the user. The control panel 40 may be provided on the main body 10 or on the door 30.

The control panel 40 may include an input button 41 and/or a display 42.

The input button 41 may obtain a user input related to an operation of the refrigerator 1. For example, the input button 41 may include a freezing temperature button 71 for inputting a target freezing temperature for controlling a temperature of the freezing compartment 23, and a refrigeration temperature button 73 for inputting a target refrigeration temperature for controlling a temperature of the refrigerating compartment 21 with respect to the refrigerating/freezing operation of the refrigerator 1.

In addition, with respect to a fermentation operation of the refrigerator 1, the input button 41 may include a fermentation start button 81 for starting the fermentation operation, a food selection button 83 for selecting a type of fermented food or fermentation ingredient, a level selection button 85 for selecting a fermentation level of fermented food, a time selection button 87 for selecting a remaining time until consumption, and a rapid fermentation button 89 for performing rapid fermentation.

The input button 41 may provide an electrical signal (user input signal) (e.g., a voltage signal or a current signal) corresponding to the user input to the processor 60. The processor 60 may identify the user input based on processing the user input signal.

The input button 41 may include a tact switch, push switch, slide switch, toggle switch, micro switch, touch switch, touch switch, or the like.

The display 42 may obtain operation information of the refrigerator 1 from the processor 60, and may display the operation information of the refrigerator 1.

For example, the display 42 may display a target temperature of the freezing compartment 23 and a target temperature of the refrigerating compartment 21 selected by a user. The display 42 may display the remaining time until consumption, the type of fermented food, and the fermentation level selected by the user. The display 42 may display whether rapid fermentation is performed. The display 42 may indicate that a fresh storage time of the fermented food is about to expire. In addition, the display 42 may indicate that production of the fermented food is completed.

The display 42 may overlap the input button 41. For example, a plurality of light emitting diodes for emitting light may be provided behind or inside the input button 41.

Some of the plurality of light emitting diodes may be provided behind or inside the freezing temperature button 71 and the refrigeration temperature button 73, and may emit light to display the target freezing temperature and target refrigeration temperature selected by the user. Some other light emitting diodes may be provided behind or inside the food selection button 83 and may emit light to display the type of fermented food selected by the user. Some other light emitting diodes may be provided behind or inside the level selection button 85 and may emit light to display the fermentation level selected by the user. Some other light emitting diodes may be provided behind or inside the time selection button 87 and may emit light to display the remaining time until consumption selected by the user. Some other light emitting diodes may be provided behind or inside the rapid fermentation button 89 and may emit light to indicate that rapid fermentation is performed.

The display 42 may include, for example, a Liquid Crystal Display (LCD) panel, a Light Emitting Diode (LED) panel, a light emitting diode, and the like.

The temperature sensor 161 may measure an internal temperature of the fermenter 100. For example, the temperature sensor 161 may be disposed in the inner case 120 insulated with the insulating material 130, and may measure a temperature of the inner case 120.

The temperature sensor 161 may provide an electrical signal (e.g., a voltage signal or a current signal) corresponding to the measured temperature to the processor 60. The processor 60 may identify the internal temperature of the fermenter 100 based on the electrical signal received from the temperature sensor 161.

The temperature sensor 161 may include, for example, a thermistor whose electrical resistance value varies with temperature.

The cooling device may include the compressor 50, the condenser, the expander, and the evaporator as described above.

The compressor 50 may compress a refrigerant gas at a high pressure, and the compressed refrigerant may be transferred to the condenser. The high-temperature, high-pressure refrigerant gas may be condensed to refrigerant liquid in the condenser. The refrigerant liquid may be expanded into a low-temperature, low-pressure refrigerant liquid in the expander, and may be evaporated into a refrigerant gas in the evaporator. While evaporating in the evaporator, the refrigerant may cool the surrounding air by absorbing heat from the surroundings. The air cooled by the evaporator may be supplied to the freezing compartment 23 and the refrigerating compartment 21.

By the compressor 50, the refrigerant may circulate through the cooling device, and the air cooled in the evaporator may be supplied to the freezing compartment 23 and the refrigerating compartment 21.

The compressor 50 may compress the gaseous refrigerant in response to a control signal from the processor 60. The compressor 50 may include a compression mechanism for compressing the refrigerant gas and a compressor motor that provides torque to the compression mechanism. The compressor motor may provide the compression mechanism with torque to compress the refrigerant gas in response to a control signal from the processor 60.

The heater 150 may be provided in the fermenter 100 and may heat the inside of the fermenter 100 in response to a control signal from the processor 60. For example, the heater 150 may be located in the inner case 120 insulated with the insulating material 130, and may heat the fermentation container 141 disposed in the inner case 120.

For example, the heater 150 may include an electrical resistor that emits heat according to current, and a power switch that controls the current supplied to the electrical resistor. The power switch may be turned on (closed) or off (open) in response to a control signal from the processor 60. While the power switch is turned on, current may be supplied to the resistor, and the heater 150 may emit heat.

The fan 160 may supply cooled air to the fermenter 100 in response to a control signal from the processor 60. The inside of the fermenter 100, i.e., the inside of the inner case 120, may be cooled by the operation of the fan 160.

For example, the fan 160 may draw the cooled air in the refrigerating compartment 21 into the fermenter 100, and the introduced air comes into contact with the fermentation container 141 to cool the fermentation container 141. As a result, the fermented food in the fermentation container 141 may also be cooled together.

The fan 160 may include fan blades that move air and a fan motor that provides torque to the fan blades. The fan motor may provide torque to the fan blades to move air in response to a control signal from the processor 60.

The processor 60 may generate a control signal to control an operation of the refrigerator 1. The processor 60 may include a memory 61 for registering and/or storing programs and data for generating control signals. The processor 60 may include one or two or more processors, and the memory 61 may be provided integrally with the processor 60 or may be provided separately from the processor 60.

The processor 60 may process data and/or signals according to the program stored in the memory 61, and may provide a control signal to each component of the refrigerator 1 based on the processing results.

The processor 60 may receive an electrical signal representing a user input of the control panel 40 and an electrical signal representing a measured temperature of the temperature sensor 161. The processor 60 may identify the user input and the measured temperature based on processing the electrical signals.

The processor 60 may provide a control signal for cooling the storage compartment 20 to the compressor 50 based on a user input. The compressor 50 may compress the refrigerant gas to circulate the refrigerant in a refrigerant circuit. The refrigerant evaporates in the evaporator, cooling the air around the evaporator.

The processor 60 may provide a control signal for fermenting the fermentation ingredients in the fermenter 100 to the heater 150 and/or the fan 160, respectively, based on the user input of the control panel 40 and/or the measured temperature of the fermenter 100.

The processor 60 may control the heater to allow the measured temperature of the fermenter 100 to follow a set target fermentation temperature during a set target fermentation time. The heater 150 may heat the fermentation container 141 and the fermentation ingredients contained therein under the control of the processor 60. Accordingly, the fermentation ingredients may be fermented in the fermentation container 141.

The processor 60 may control the fan 160 to cool the fermented food in a case where the set target fermentation time has elapsed. Once fermentation of the fermentation ingredients is completed, the fan 160 may supply the cooled air to the inside of the fermenter 100. Accordingly, overfermentation of the fermentation ingredients in the fermentation container 141 may be suppressed, prevented, or anticipated, and the fermented food may be stored in a refrigerated state.

As such, the processor 60 may produce the fermented food by heating the fermentation container 141 in the fermenter 100 and then cooling the fermentation container 141.

The target fermentation time and target fermentation temperature for fermented food may depend on the fermented food and/or fermentation ingredients.

The above-described control panel 40 may be provided with the food selection button 83 for selecting the type of fermented food or fermentation ingredients. Any one of dairy products, pickles, or fermented bread dough may be selected with the food selection button 83. The fermented foods are not limited to the dairy products, pickles, and fermented bread dough, and various types of fermented foods may be prepared.

For example, fermented food as dairy products may include curd from India, laban from the Middle East, ayran from Turkey, dahi from Pakistan, Sua Chua from Vietnam, and the like. In preparing curd from India, the target fermentation temperature may be approximately 43 to 46 degrees Celsius, and the target fermentation time may be approximately 8 to 12 hours. In preparing Laban from the Middle East, the target fermentation temperature may be approximately 42 to 48 degrees Celsius, and the target fermentation time may be approximately 4 to 12 hours. In preparing ayran from Turkey, the target fermentation temperature may be approximately 43 degrees Celsius, and the target fermentation time may be approximately 4 to 6 hours. In preparing dahi from Pakistan, the target fermentation temperature may be approximately 43 to 46 degrees Celsius, and the target fermentation time may be approximately 12 hours. In preparing Sua Chua from Vietnam, the target fermentation temperature may be approximately 80 to 90 degrees Celsius, and the target fermentation time may be approximately 5 to 8 hours.

Fermented food as pickles may include avakaya, i.e., mango pickles from India, torshi from the Middle East, tursu from Turkey, ackaar from Pakistan, acar from Indonesia, tempoyak, i.e., durian pickles from Malaysia, nhut mit. i.e., fruit pickles from Vietnam, and the like. In preparing mango pickles from India, the target fermentation temperature may be approximately 20 degrees Celsius, and the target fermentation time may be approximately 2 to 14 days. In preparing torshi from the Middle East, the target fermentation temperature may be approximately 25 degrees Celsius, and the target fermentation time may be approximately 2 weeks to 3 months. In preparing tursu from Turkey, the target fermentation temperature may be approximately 20 degrees Celsius, and the target fermentation time may be approximately 2 to 4 weeks. In preparing ackaar from Pakistan, the target fermentation temperature may be approximately 20 degrees Celsius, and the target fermentation time may be approximately 2 to 3 days. In preparing acar from Indonesia, the target fermentation temperature may be approximately 0 to 10 degrees Celsius, and the target fermentation time may be approximately 1 to 2 days. In preparing durian pickles from Malaysia, the target fermentation temperature may be approximately 20 degrees Celsius, and the target fermentation time may be approximately 3 to 5 days. In preparing fruit pickles from Vietnam, the target fermentation temperature may be approximately 22 to 25 degrees Celsius, and the target fermentation time may be approximately 5 to 7 days.

Fermented food as fermented bread dough may include idli, dosa, and naan from India. In preparing idli or dosa, the target fermentation temperature may be approximately 20 degrees Celsius, and the target fermentation time may be approximately 8 to 12 hours. In preparing naan, the target fermentation temperature may be approximately 25 degrees Celsius, and the target fermentation time may be approximately 8 to 12 hours.

The processor 60 may control the heater to allow a measured temperature of the fermenter 100 to follow a target fermentation temperature determined according to a fermented food selected by a user during a target fermentation time determined according to the selected fermented food.

In addition, the target fermentation time and the target fermentation temperature for fermented food may depend on a fermentation level.

The control panel 40 described above may be provided with the level selection button 85 for selecting the fermentation level. Any one of a first fermentation level, a second fermentation level, or a third fermentation level may be selected with the level selection button 85. The fermentation level is not limited to the three levels, and may include two levels or four or more levels.

For example, as the fermentation level increases, the target fermentation temperature may increase or the target fermentation time may become longer. In addition, as the fermentation level decreases, the target fermentation temperature may decrease or the target fermentation time may become shorter.

In addition, the target fermentation time and the target fermentation temperature for fermented food may depend on whether rapid fermentation is performed.

The control panel 40 described above may be provided with the rapid fermentation button 89 for performing rapid fermentation. The rapid fermentation button 89 may be used to select whether or not to perform rapid fermentation. For example, a target fermentation time for rapid fermentation may be shorter than a target fermentation time for normal fermentation, and a target fermentation temperature for rapid fermentation may be higher than a target fermentation temperature for normal fermentation.

As described above, the refrigerator 1 may include the fermenter 100 to produce various fermented foods. The refrigerator 1 may produce various fermented foods at various fermentation levels, and may also produce fermented foods faster in response to the user's selection.

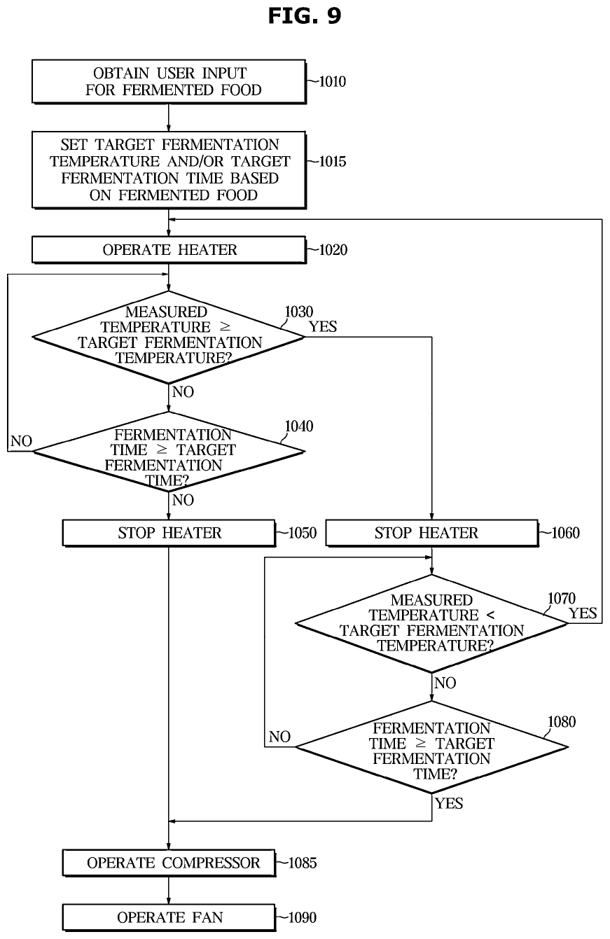

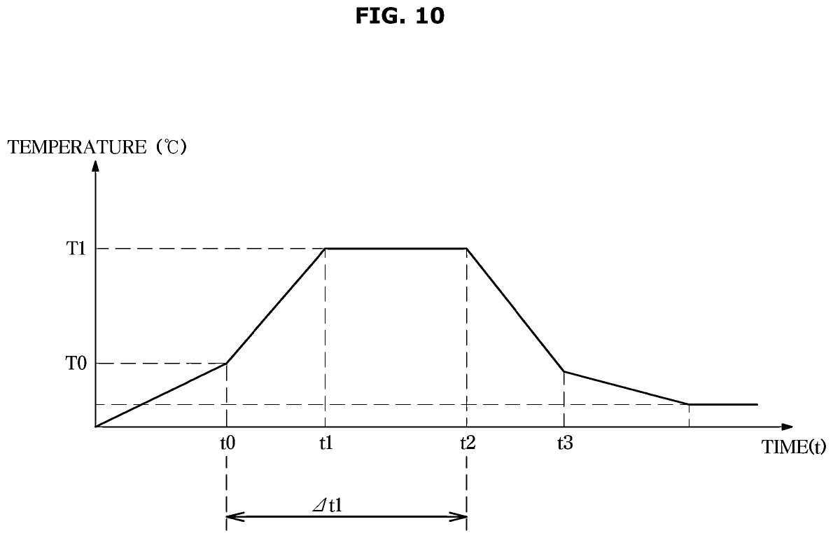

FIG. 9 illustrates an example of operations for producing fermented food by a refrigerator according to an embodiment. FIG. 10 illustrates a change in an internal temperature of a fermenter due to the operations shown in FIG. 9.

Fermentation operations 1000 of the refrigerator 1 are described with reference to FIG. 9 and FIG. 10.

The refrigerator 1 may obtain a user input for fermented food (1010).

For example, a user may place fermentation ingredients in the fermentation container 141 and mount the fermentation container 141 to the fermenter 100. Thereafter, the user may enter a user input for fermented food via the control panel 40.

The control panel 40 of the refrigerator 1 may include the food selection button 83 for selecting a type of fermented food or fermentation ingredients. For example, types of fermented foods may include dairy products, pickles, and/or fermented bread dough.

The processor 60 may receive an electrical signal corresponding to the user input via the food selection button 83, and may identify the fermented food based on the electrical signal received from the control panel 40.

The refrigerator 1 may set a target fermentation temperature and target fermentation time based on the fermented food (1015).

A table including target fermentation temperatures and target fermentation times depending on the fermented food may be stored in advance in the memory 61.

The processor 60 may set the target fermentation temperature and target fermentation time by referring to the table stored in the memory 61.

The refrigerator 1 may operate the heater 150 to perform fermentation (1020).

For example, the processor 60 may control the power switch of the heater 150 to supply power to the electrical resistor included in the heater 150.

The heat emitted from the heater 150 may heat the fermentation container 141 and the fermentation ingredients contained therein in the inner case 120, and temperatures of the fermentation container 141 and the fermentation ingredients may increase.

The refrigerator 1 may identify whether a measured internal temperature of the fermenter 100 is greater than or equal to a target temperature (hereinafter referred to as “target fermentation temperature”) for fermentation (1030).

For example, the temperature sensor 161 may be located in the fermenter 100 and may measure an internal temperature of the fermenter 100. The internal temperature of the fermenter 100 may be approximately similar to the temperature of the fermentation container 141, and the temperature sensor 161 may measure the temperature of the fermentation container 141 and the fermentation ingredients contained therein. The temperature sensor 161 may provide an electrical signal corresponding to the measured temperature to the processor 60.

The processor 60 may identify the internal temperature of the fermenter 100 based on an output signal of the temperature sensor 161. The processor 60 may compare the identified temperature with the target fermentation temperature according to the fermented food, and may identify whether the measured internal temperature of the fermenter 100 is greater than or equal to the target fermentation temperature based on the comparison.

Here, the target fermentation temperature may depend on the fermented food or fermentation ingredients. In other words, the target fermentation temperatures may be different for different fermented foods.

Based on the measured internal temperature of the fermenter 100 being lower than the target fermentation temperature (No in operation 1030), the refrigerator 1 may identify whether a time for which fermentation has been performed (hereinafter referred to as “fermentation time”) is greater than or equal to the target fermentation time for fermentation (1040).

For example, the processor 60 may include a counter and may use the counter to identify the fermentation time.

Fermentation ingredients may have various temperatures depending on a storage environment. For example, in a case where the fermentation ingredients are refrigerated for storage, a temperature of the fermentation ingredients may be approximately between 2 and 5 degrees Celsius. In addition, in a case where fermentation ingredients are stored at room temperature, a temperature of the fermentation ingredients may be approximately between 20 and 25 degrees Celsius. Accordingly, the time to reach the temperature at which lactobacillus are maximally activated for fermentation (e.g., a temperature between 35 and 45 degrees Celsius) may vary, and the fermentation time may be inaccurate.

In order to specify an accurate fermentation time, the refrigerator 1 may determine that fermentation has started once the temperature measured by the temperature sensor 161 reaches a specific temperature TO. In other words, the processor 60 may start counting the fermentation time at a time t0 when the measured temperature reaches the temperature TO.

The processor 60 may count the fermentation time. The processor 60 may compare the counted fermentation time with the target fermentation time according to the fermented food, and may identify whether the counted fermentation time is greater than or equal to the target fermentation time based on the comparison.

Here, the target fermentation time may depend on fermented food or fermentation ingredients. In other words, the target fermentation times may be different for different fermented foods.

Based on the fermentation time being less than the target fermentation time (No in operation 1040), the refrigerator 1 may repeat comparing the measured temperature with the target fermentation temperature while the heater is running.

Based on the fermentation time being greater than the target fermentation time (No in operation 1040), the refrigerator 1 may stop the heater 150 to suppress or prevent overfermentation due to the fermentation time (1050).

For example, the processor 60 may identify that production of the fermented food is completed based on the fermentation time being greater than the target fermentation time.

The processor 60 may control the power switch of the heater 150 to stop supplying power to the electrical resistor. Due to the operation stoppage of the heater 150 and cooled air around the fermenter 100, the temperature of the fermentation container 141 and the fermentation ingredients contained therein may decrease.

Based on the measured temperature being greater than or equal to the target fermentation temperature in operation 1030 (Yes in operation 1030), the refrigerator 1 may stop the heater 150 to suppress or prevent overfermentation due to the fermentation temperature (1060).

For example, the processor 60 may identify that bacteria for fermentation are maximally activated based on the measured temperature being greater than or equal to the target temperature. The processor 60 may stop the heater 150 to maintain a temperature for maximum activation of the bacteria.

Operation 1060 may be the same as operation 1050 described above.

As such, the processor 60 may turn on or off the heater 150 based on comparison between the measured temperature and the target fermentation temperature in order to allow the internal temperature of the fermenter 100 to follow the target fermentation temperature.

As such, by the operation of the heater 150, the internal temperature of the fermenter 100 increases between the time t0 and a time t1, as shown in FIG. 10, and may reach a target fermentation temperature T1 at the time t1. Thereafter, the heater 150 may be repeatedly turned on and off, and the internal temperature of the fermenter 100 may be maintained at approximately the target fermentation temperature T1.

The refrigerator 1 may identify whether a measured internal temperature of the fermenter 100 is less than the target fermentation temperature (1070).

For example, the processor 60 may identify the internal temperature of the fermenter 100 based on an output signal of the temperature sensor 161. The processor 60 may compare the identified temperature with the target fermentation temperature according to the fermented food, and may identify whether the measured internal temperature of the fermenter 100 is less than the target fermentation temperature based on the comparison.

Based on the measured internal temperature of the fermenter 100 being less than the target fermentation temperature (Yes in operation 1070), the refrigerator 1 may operate the heater 150 for fermentation (1020).

For example, the processor 60 may operate the heater 150 to allow the measured temperature to be maintained at a temperature at which bacteria for fermentation are maximally activated.

Based on the measured internal temperature of the fermenter 100 being greater than or equal to the target fermentation temperature (No in operation 1070), the refrigerator 1 may identify whether a fermentation time is greater than or equal to the target fermentation time (1080).

Operation 1080 may be the same as operation 1040 described above.

Based on the fermentation time being less than the target fermentation time (No in operation 1080), the refrigerator 1 may repeat comparing the measured temperature with the target fermentation temperature while the heater is stopped.

Based on the fermentation time being greater than or equal to the target fermentation time (Yes in operation 1080), the refrigerator 1 may identify that production of the fermented food is completed.

The refrigerator 1 may operate the compressor 50 (1085).

As will be described below, in response to completion of the production of the fermented food, the processor 60 may cool the fermentation container 141 and the fermented food contained therein in order to keep the fermented food refrigerated. In other words, a heat load in the refrigerator 1 may increase. As a result, a temperature of the refrigerating compartment 21 or the freezing compartment 23 may rise above an appropriate temperature.

The processor 60 may operate the compressor 50 in preparation for an increase in heat load for cooling the fermented food. By operating the compressor 50, a refrigerant may be evaporated in the evaporator, and air around the evaporator may be cooled.

It has been described above that the processor 60 operates the compressor 50 immediately after the fermentation time reaches the target fermentation time, but the disclosure is not limited thereto. For example, the processor 60 may lower the temperature of the refrigerating compartment 21 in advance by operating the compressor 50 before the fermentation time reaches the target fermentation time.

The refrigerator 1 may operate the fan 160 (1090).

For example, the processor 60 may operate the fan 160 to cool the fermentation container 141 and the fermented food contained therein. By operating the fan 160, cooled air from the refrigerating compartment 21 may be introduced into the fermenter 100, and the inside of the fermenter 100 may be cooled.

As shown in FIG. 10, the processor 60 may identify that the production of the fermented food is completed at a time t2, and may continuously operate the fan 160. Accordingly, the internal temperature of the fermenter 100 may rapidly drop from the time t2 to a time t3.

At the time t3, the processor 60 may intermittently operate the fan 160. In other words, the processor 60 may repeat turning the fan 160 on and off. As a result, the internal temperature of the fermenter 100 may slowly decrease.

As described above, the refrigerator 1 may control the fermenter 100 to allow the internal temperature of the fermenter 100 to follow the target fermentation temperature determined according to the fermented food during the target fermentation time determined according to the fermented food. Thereafter, the refrigerator 1 may cool the inside of the fermenter 100.

Accordingly, the refrigerator 1 may produce a variety of fermented foods, and the produced fermented foods may be refrigerated immediately.

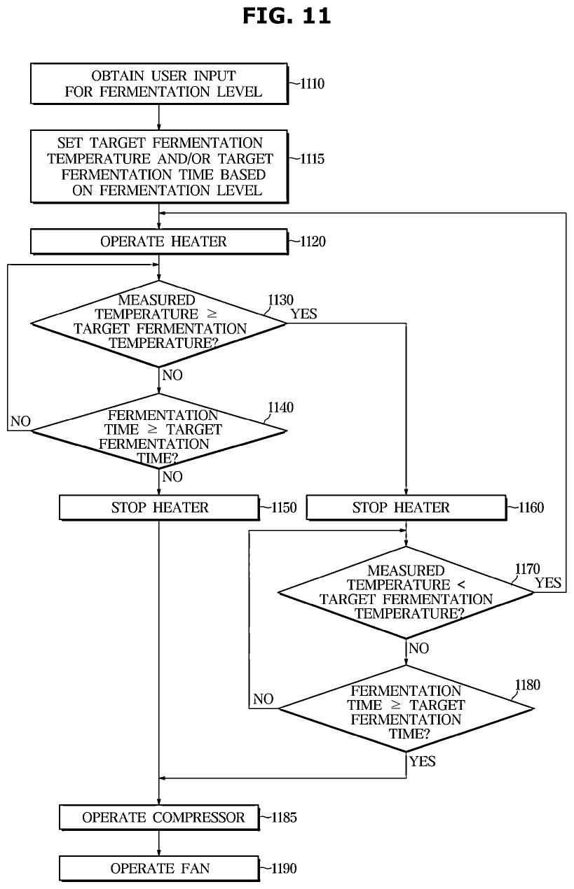

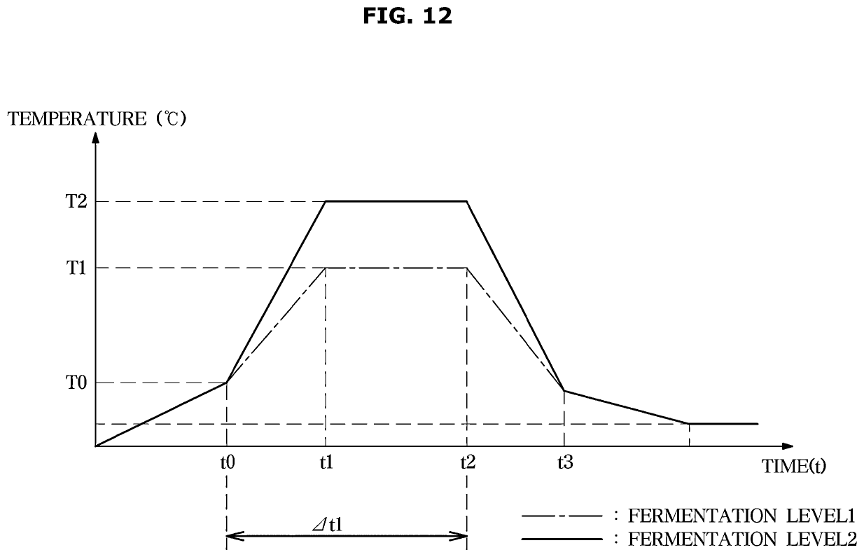

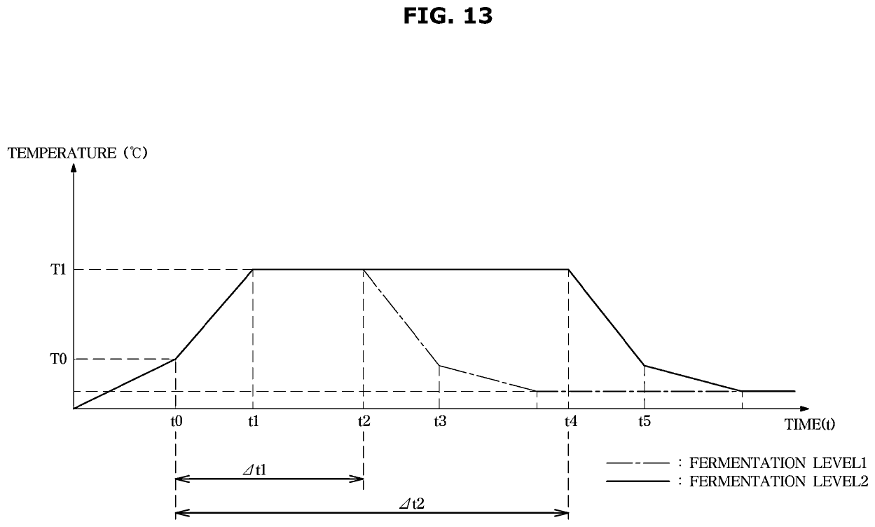

FIG. 11 illustrates an example of operations for producing fermented food by a refrigerator according to an embodiment. FIG. 12 illustrates an example of a change in an internal temperature of a fermenter due to the operations shown in FIG. 11. FIG. 13 illustrates another example of a change in an internal temperature of a fermenter due to the operations shown in FIG. 11.

Fermentation operations 1100 of the refrigerator 1 are described with reference to FIG. 11, FIG. 12 and FIG. 13.

The refrigerator 1 may obtain a user input for a fermentation level (1110).

For example, the control panel 40 of the refrigerator 1 may include the level selection button 85 for selecting a fermentation level. The level selection button 85 may include a button for selecting any one of a first fermentation level, a second fermentation level, or a third fermentation level.

A user may enter a user input to select the fermentation level via the control panel 40.

The processor 60 may receive an electrical signal corresponding to the user input via the level selection button 85, and may identify the fermentation level based on the electrical signal received from the control panel 40.

The refrigerator 1 may set a target fermentation temperature and a target fermentation time based on the fermentation level (1115).

A table including target fermentation temperatures and target fermentation times depending on the fermentation level may be stored in advance in the memory 61. For example, the table including a first target temperature T1 and a first target time Δt1 corresponding to the first fermentation level, and a second target temperature T2 and a second target time Δt2 corresponding to the second fermentation level may be stored in the memory 61 in advance.

The processor 60 may set the target fermentation temperature and the target fermentation time by referring to the table stored in the memory 61. As the fermentation level increases, the target fermentation temperature may increase, and as the fermentation level decreases, the target fermentation temperature may decrease. For example, the second target temperature T2 of the second fermentation level may be higher than the first target temperature T1 of the first fermentation level.

In addition, as the fermentation level increases, the target fermentation time may become longer, and as the fermentation level decreases, the target fermentation time may become shorter. For example, the second target time Δt2 of the second fermentation level may be longer than the first target time Δt1 of the first fermentation level.

The refrigerator 1 may operate the heater 150 to perform fermentation (1120). The refrigerator 1 may identify whether a measured internal temperature of the fermenter 100 is greater than or equal to the target fermentation temperature (1130). Based on the measured internal temperature of the fermenter 100 being lower than the target fermentation temperature (No in operation 1130), the refrigerator 1 may identify whether a fermentation time is greater than or equal to the target fermentation time for fermentation (1140). Based on the fermentation time being less than the target fermentation time (No in operation 1140), the refrigerator 1 may repeat comparing the measured temperature with the target fermentation temperature while the heater is running. Based on the fermentation time being greater than the target fermentation time (Yes in operation 1140), the refrigerator 1 may stop the heater 150 to suppress or prevent overfermentation due to the fermentation time (1150).

Operations 1120, 1130, 1140, and 1150 may be the same as operations 1020, 1030, 1040, and 1050 shown in FIG. 9.

Based on the measured temperature being greater than or equal to the target fermentation temperature in operation 1130 (Yes in operation 1130), the refrigerator 1 may stop the heater 150 to suppress or prevent overfermentation due to the fermentation temperature (1160).

Operation 1160 may be the same as operation 1060 shown in FIG. 9.

For example, the processor 60 may turn on or off the heater 150 based on the comparison between the measured temperature and the target fermentation temperature in order to allow the internal temperature of the fermenter 100 to follow the target fermentation temperature.

The target fermentation temperature may depend on the fermentation level. For example, the second target temperature T2 of the second fermentation level may be higher than the first target temperature T1 of the first fermentation level. Accordingly, as shown in FIG. 12, the internal temperature of the fermenter 100 in the second fermentation level may be maintained higher than the internal temperature of the fermenter 100 in the first fermentation level. In the second fermentation level, bacteria may be more activated than in the first fermentation level, and fermentation of the food may be promoted.

As a result, the food fermented in the second fermentation level may be aged more than the food fermented in the first fermentation level.

The refrigerator 1 may identify whether a measured internal temperature of the fermenter 100 is less than the target fermentation temperature for fermentation (1170). Based on the measured internal temperature of the fermenter 100 being less than the target fermentation temperature (Yes in operation 1170), the refrigerator 1 may operate the heater 150 for fermentation (1120). Based on the measured internal temperature of the fermenter 100 being greater than or equal to the target fermentation temperature (No in operation 1170), the refrigerator 1 may identify whether a fermentation time is greater than or equal to the target fermentation time for fermentation (1180).

Operation 1170 and operation 1180 may be the same as operation 1070 and operation 1080 shown in FIG. 9.

Based on the fermentation time being greater than or equal to the target fermentation time (Yes in operation 1180), the refrigerator 1 may operate the compressor 50 (1185) and operate the fan 160 (1190).

Operation 1185 and operation 1190 may be the same as operation 1085 and operation 1090 shown in FIG. 9.

As shown in FIG. 13, in the first fermentation level, the processor 60 may identify that production of the fermented food is completed at a time t2 at which the first target time Δt1 has elapsed after a time t0. In comparison, in the second fermentation level, the processor 60 may identify that production of the fermented food is completed at a time t4 at which the second target time Δt2 has elapsed after the time t0. A time interval between the time t0 and the time t4 may be longer than a time interval between the time t0 and the time t2. Accordingly, an operating time of the fermenter 100 in the second fermentation level may be longer than that of the fermenter 100 in the first fermentation level. In the second fermentation level, bacteria may be activated for a longer time than in the first fermentation level, and fermentation of food may be further aged.

As a result, the food fermented in the second fermentation level may be aged more than the food fermented in first fermentation level.

As described above, the refrigerator 1 may control the fermenter 100 to allow the internal temperature of the fermenter 100 to follow the target fermentation temperature determined according to the fermentation level during the target fermentation time determined according to the fermentation level. Accordingly, the refrigerator 1 may provide a user with fermented foods having different fermentation levels according to the user's preference.

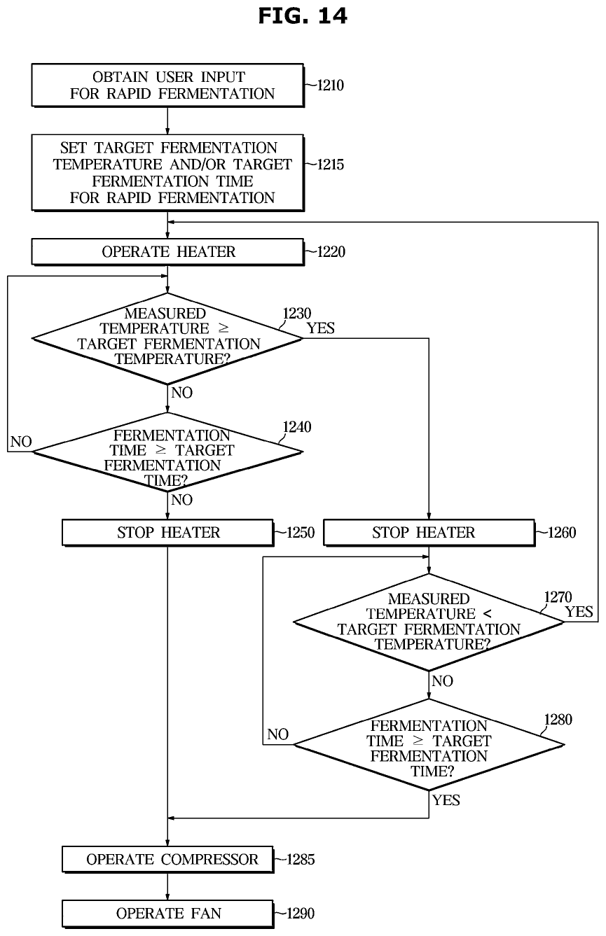

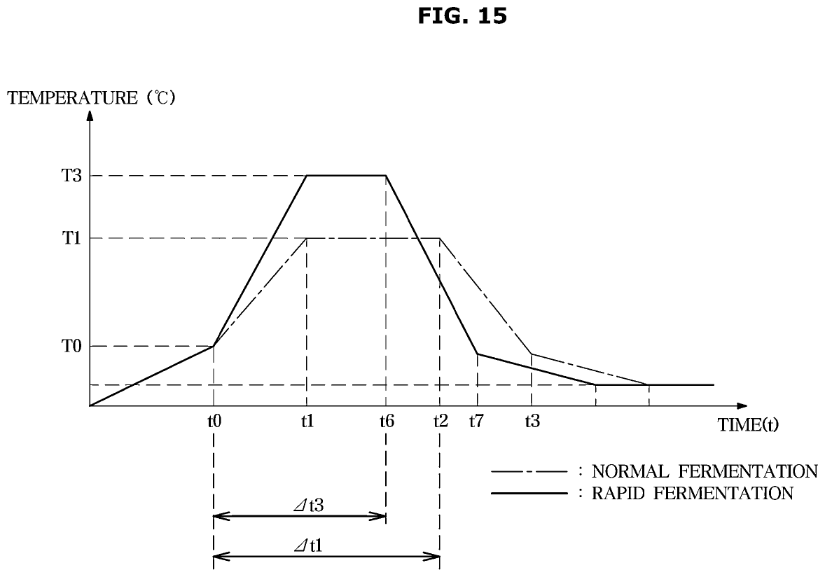

FIG. 14 illustrates an example of operations for producing fermented food by a refrigerator according to an embodiment. FIG. 15 illustrates an example of a change in an internal temperature of a fermenter due to the operations shown in FIG. 14.

Fermentation operations 1200 of the refrigerator 1 are described with reference to FIG. 14 and FIG. 15.

The refrigerator 1 may obtain a user input for rapid fermentation (1210).

For example, the control panel 40 of the refrigerator 1 may include the rapid fermentation button 89 for performing rapid fermentation. A user may enter a user input for rapid fermentation via the control panel 40.

The processor 60 may receive an electrical signal corresponding to the user input via the rapid fermentation button 89, and may identify the user input for rapid fermentation based on the electrical signal received from the control panel 40.

The refrigerator 1 may set a target fermentation temperature and a target fermentation time for rapid fermentation (1215).

A table including target fermentation temperatures and target fermentation times for each of normal fermentation and rapid fermentation may be stored in advance in the memory 61. For example, a table including a first target temperature T1 and a first target time Δt1 corresponding to normal fermentation and a third target temperature T3 and a third target time Δt3 corresponding to rapid fermentation may be stored in the memory 61 in advance.

The processor 60 may set the target fermentation temperature and target fermentation time by referring to the table stored in the memory 61. A target fermentation temperature for rapid fermentation may be higher than a target fermentation temperature for normal fermentation. For example, the third target temperature T3 of rapid fermentation may be higher than the first target temperature T1 of normal fermentation.

In addition, the target fermentation time of rapid fermentation may be shorter than the target fermentation time of normal fermentation. For example, the third target time Δt3 of rapid fermentation may be shorter than the first target time Δt1 of normal fermentation.

The refrigerator 1 may operate the heater 150 to perform fermentation (1220). The refrigerator 1 may identify whether a measured internal temperature of the fermenter 100 is greater than or equal to the target fermentation temperature (1230). Based on the measured internal temperature of the fermenter 100 being lower than the target fermentation temperature (No in operation 1230), the refrigerator 1 may identify whether a fermentation time is greater than or equal to the target fermentation time for fermentation (1240). Based on the fermentation time being less than the target fermentation time (No in operation 1240), the refrigerator 1 may repeat comparing the measured temperature with the target fermentation temperature while the heater is running. Based on the fermentation time being greater than or equal to the target fermentation time (Yes in operation 1240), the refrigerator 1 may stop the heater 150 to suppress or prevent overfermentation due to the fermentation time (1250).

Operations 1220, 1230, 1240, and 1250 may be the same as operations 1020, 1030, 1040, and 1050 shown in FIG. 9.

Based on the measured temperature being greater than or equal to the target fermentation temperature in operation 1230 (Yes in operation 1230), the refrigerator 1 may stop the heater 150 to suppress or prevent overfermentation due to the fermentation temperature (1260).

Operation 1260 may be the same as operation 1060 shown in FIG. 9.

For example, the processor 60 may turn on or off the heater 150 based on the comparison between the measured temperature and the target fermentation temperature in order to allow the internal temperature of the fermenter 100 to follow the target fermentation temperature.

The target fermentation temperature may depend on whether or not to perform rapid fermentation. For example, the third target temperature T3 of rapid fermentation may be higher than the first target temperature T1 of normal fermentation. Accordingly, as shown in FIG. 15, the internal temperature of the fermenter 100 in rapid fermentation may be maintained higher than the internal temperature of the fermenter 100 in normal fermentation. In rapid fermentation, bacteria may be more activated than in normal fermentation, and fermentation of the food may be promoted.

As a result, the food fermented by rapid fermentation may be aged faster than food fermented by normal fermentation.

The refrigerator 1 may identify whether a measured internal temperature of the fermenter 100 is less than the target fermentation temperature (1270). Based on the measured internal temperature of the fermenter 100 being less than the target fermentation temperature (Yes in operation 1270), the refrigerator 1 may operate the heater 150 for fermentation (1220). Based on the measured internal temperature of the fermenter 100 being greater than or equal to the target fermentation temperature (No in operation 1270), the refrigerator 1 may identify whether a fermentation time is greater than or equal to the target fermentation time for fermentation (1280).

Operation 1270 and operation 1280 may be the same as operation 1070 and operation 1080 shown in FIG. 9.

Based on the fermentation time being greater than or equal to the target fermentation time (Yes in operation 1280), the refrigerator 1 may operate the compressor 50 (1285) and operate the fan 160 (1290).

Operation 1285 and operation 1290 may be the same as operation 1085 and operation 1090 shown in FIG. 9.

As shown in FIG. 15, in normal fermentation, the processor 60 may identify that production of the fermented food is completed at a time t2 at which the first target time Δt1 has elapsed after a time t0. In comparison, in rapid fermentation, the processor 60 may identify that production of the fermented food is completed at a time t6 at which the third target time Δt3 has elapsed after a time t0. A time interval between the time t0 and the time t6 may be shorter than a time interval between the time t0 and the time t2.

As a result, an operating time of the fermenter 100 in rapid fermentation may be shorter than that of the fermenter 100 in normal fermentation.

As described above, the refrigerator 1 may control the fermenter 100 to allow the internal temperature of the fermenter 100 to follow the target fermentation temperature determined for rapid fermentation during the target fermentation time determined for rapid fermentation. Accordingly, the refrigerator 1 may rapidly produce the fermented food in response to the user input.

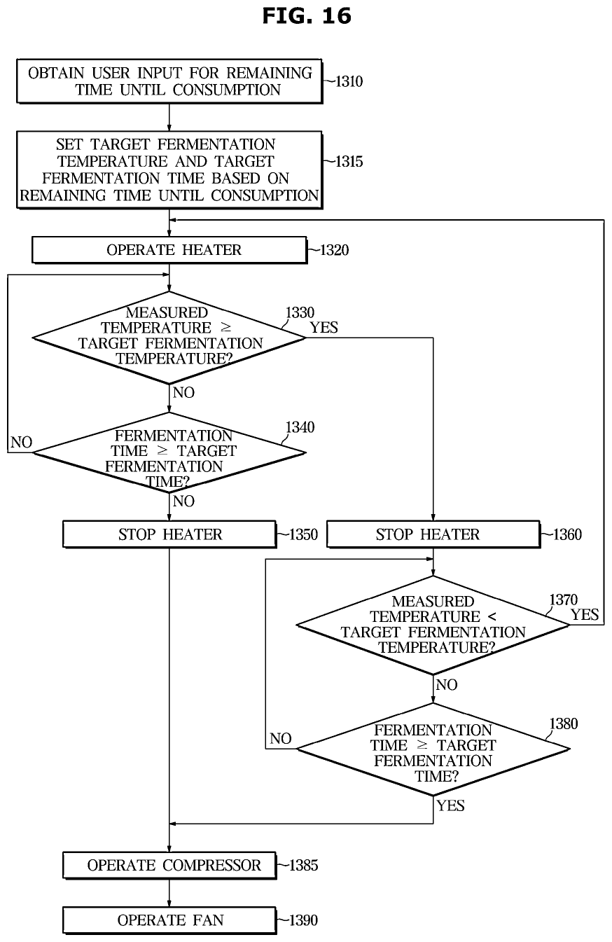

FIG. 16 illustrates an example of operations for producing fermented food by a refrigerator according to an embodiment.

Fermentation operations 1300 of the refrigerator 1 are described with reference to FIG. 16.

The refrigerator 1 may obtain a user input for a remaining time until consumption (1310).

For example, the control panel 40 of the refrigerator 1 may include the time selection button 87 for selecting a remaining time until consumption. A user may enter a user input for the remaining time until consumption via the control panel 40.

The processor 60 may receive an electrical signal corresponding to the user input via the time selection button 87, and may identify the user input for the remaining time until consumption based on the electrical signal received from the control panel 40.

The refrigerator 1 may set a target fermentation temperature and a target fermentation time depending on the remaining time until consumption (1315).

A table including target fermentation temperatures and target fermentation times depending on the remaining time until consumption may be stored in advance in the memory 61.

The processor 60 may set the target fermentation temperature and target fermentation time by referring to the table stored in the memory 61.

In a case where the remaining time until consumption is greater than or equal to a first target time for normal fermentation, the processor 60 may set the target fermentation time as a first target time Δt1 for normal fermentation and set the target fermentation temperature as a first target temperature T1 for normal fermentation.

In a case where the remaining time until consumption is shorter than the first target time for normal fermentation, the processor 60 may set the target fermentation time as the remaining time until consumption and may set the target fermentation temperature depending on the remaining time until consumption. For example, the shorter the remaining time until consumption, the higher the target fermentation temperature may be.

The refrigerator 1 may operate the heater 150 to perform fermentation (1320). The refrigerator 1 may identify whether a measured internal temperature of the fermenter 100 is greater than or equal to the target fermentation temperature (1330). Based on the measured internal temperature of the fermenter 100 being lower than the target fermentation temperature (No in operation 1330), the refrigerator 1 may identify whether a fermentation time is greater than or equal to the target fermentation time (1340). Based on the fermentation time being less than the target fermentation time (No in operation 1340), the refrigerator 1 may repeat comparing the measured temperature with the target fermentation temperature while the heater is running. Based on the fermentation time being greater than or equal to the target fermentation time (Yes in operation 1340), the refrigerator 1 may stop the heater 150 to suppress or prevent overfermentation due to the fermentation time (1350).

Operations 1320, 1330, 1340, and 1350 may be the same as operations 1020, 1030, 1040, and 1050 shown in FIG. 9.

Based on the measured temperature being greater than or equal to the target fermentation temperature in operation 1330 (Yes in operation 1330), the refrigerator 1 may stop the heater 150 to suppress or prevent overfermentation due to the fermentation temperature (1360).

Operation 1360 may be the same as operation 1060 shown in FIG. 9.

For example, the processor 60 may turn on or off the heater 150 based on the comparison between the measured temperature and the target fermentation temperature to allow the internal temperature of the fermenter 100 to follow the target fermentation temperature. Here, the target fermentation temperature may depend on the remaining time until consumption. For example, in a case where the remaining time until consumption is greater than or equal to the first target time of normal fermentation, the target fermentation temperature may be the same as the first target temperature of normal fermentation. In addition, in a case where the remaining time until consumption is shorter than the first target time of normal fermentation, the shorter the remaining time until consumption, the higher the target fermentation temperature may be.

As a result, the refrigerator 1 may provide sufficiently aged fermented food at the time desired by the user.

The refrigerator 1 may identify whether a measured internal temperature of the fermenter 100 is less than the target fermentation temperature (1370). Based on the measured internal temperature of the fermenter 100 being less than the target fermentation temperature (Yes in operation 1370), the refrigerator 1 may operate the heater 150 for fermentation (1320). Based on the measured internal temperature of the fermenter 100 being greater than or equal to the target fermentation temperature (No in operation 1370), the refrigerator 1 may identify whether a fermentation time is greater than or equal to the target fermentation time for fermentation (1380).

Operation 1370 and operation 1380 may be the same as operation 1070 and operation 1080 shown in FIG. 9.

Based on the fermentation time being greater than or equal to the target fermentation time (Yes in operation 1380), the refrigerator 1 may operate the compressor 50 (1385) and operate the fan 160 (1390).

Operation 1385 and operation 1390 may be the same as operation 1085 and operation 1090 shown in FIG. 9.

For example, the processor 60 may identify that production of fermented food is completed in a case where an elapsed time after a start of fermentation is greater than or equal to the target fermentation time. Here, in a case where the remaining time until consumption is greater than or equal to the first target time of normal fermentation, the target fermentation time may be the same as the first target time of normal fermentation. In addition, in a case where the remaining time until consumption is shorter than the first target time of normal fermentation, the target fermentation time may be the same as the remaining time until consumption.

As a result, the refrigerator 1 may provide the fermented food at the time desired by the user.

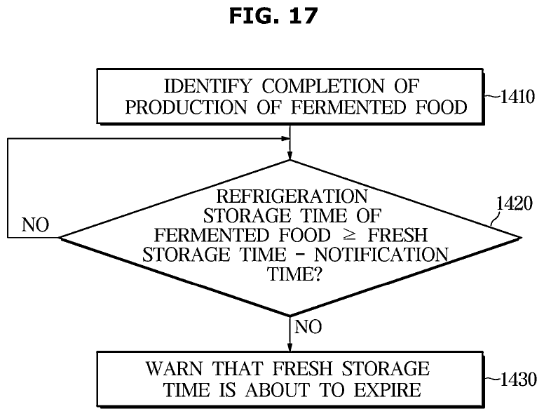

FIG. 17 illustrates an example of warning that a fresh storage time of fermented food is about to expire by a refrigerator according to an embodiment.

Warning operations 1400 of the refrigerator 1 are described with reference to FIG. 17.

The refrigerator 1 may identify completion of production of the fermented food (1410).

For example, the processor 60 may identify completion of production of the fermented food based on a time for producing the fermented food being greater than or equal to a target fermentation time.

Thereafter, the processor 60 may control the fan 160 to cool the produced fermented food. Accordingly, the fermented food may be stored refrigerated.

The refrigerator 1 may identify whether a refrigeration storage time of the fermented food is greater than or equal to a difference between a fresh storage time and a notification time (1420).

For example, the processor 60 may include a timer, and may use the timer to identify an elapsed time after the fermented food has been produced.

In the memory 61, a fresh storage time for each fermented food may be stored in advance. The fresh storage time for dairy products may be approximately 7 to 14 days, the fresh storage time for pickles may be approximately 1 month, and the fresh storage time for fermented bread dough may be approximately 3 to 5 days.

The notification time is a time to warn the user that the fresh storage time of fermented food is about to expire. The notification time may be, for example, 1 day, and may be stored in the memory 61 in advance.

The processor 60 may compare a time for which the fermented food has been refrigerated with the difference between the fresh storage time and the notification time, and may identify whether the time for which the fermented food has been refrigerated is greater than or equal to the difference between the fresh storage time and the notification time.

Based on the refrigeration storage time of the fermented food being less than the difference between the fresh storage time and the notification time (No in operation 1420), the refrigerator 1 may continue refrigerated storage of the fermented food.

Based on the refrigeration storage time of the fermented food being greater than or equal to the difference between the fresh storage time and the notification time (Yes in operation 1420), the refrigerator 1 may warn that the fresh storage time of the fermented food is about to expire (1430).

For example, the processor 60 may output an audio message or a video message to warn that the fresh storage time of fermented food is about to expire. For example, the processor 60 may control a warning indicator 91 to emit light.

As a result, the refrigerator 1 may guide the user to consume the produced fermented food before the food spoils.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that may be interpreted by a computer. For example, the computer-readable recording medium may be a Read Only Memory (ROM), a Random Access Memory (RAM), a magnetic tape, a magnetic disk, a flash memory, an optical data storage device, etc.

The machine-readable storage medium may be provided in the form of a non-transitory storage medium. Here, when a storage medium is referred to as “non-transitory,” it may be understood that the storage medium is tangible and does not include a signal (e.g., an electromagnetic wave), but rather that data is semi-permanently or temporarily stored in the storage medium. For example, a “non-transitory storage medium” may include a buffer in which data is temporarily stored.

According to an embodiment, the method according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the disclosure have been described with reference to the accompanying drawings, those skilled in the art will appreciate that these inventive concepts may be embodied in different forms without departing from the scope and spirit of the disclosure, and should not be construed as limited to the embodiments set forth herein.

What is claimed is:

1. A refrigerator, comprising:
a main body;
a control panel arranged on one surface of the main body;
a storage compartment arranged in the main body;
a case arranged in the storage compartment;
a heater arranged in the case;
a fan configured to introduce air from outside the case into the case; and
a processor configured to:
control the heater to maintain a temperature in the case at a fermentation temperature for a fermentation time based on receiving a user input from the control panel,
wherein the processor is configured to:
control the heater based on receiving a user input for a normal fermentation through the control panel, the heater being controlled to maintain a temperature in the case at a first temperature for a first time period, and
control the heater based on receiving a user input for a rapid fermentation through the control panel to maintain the temperature in the case at a second temperature higher than the first temperature for a second time period shorter than the first time period.

2. The refrigerator of claim 1, wherein the processor is configured to control the fan to introduce air in the storage compartment into the case based on the fermentation time having elapsed.

3. The refrigerator of claim 1, wherein the processor is configured to:
receive a user input for fermented food through the control panel; and
control the heater to maintain the temperature in the case at different temperatures based on user inputs for different fermented foods.

4. The refrigerator of claim 1, wherein the processor is configured to:
receive a user input for fermented food through the control panel; and
control the heater to maintain the temperature in the case at a corresponding fermentation temperature for different time periods based on user inputs for different fermented foods.

5. The refrigerator of claim 1, wherein the processor is configured to:
control the heater to maintain the temperature in the case at the first temperature based on receiving a user input for selecting a first fermentation level through the control panel; and
control the heater to maintain the temperature in the case at a third temperature higher than the first temperature based on receiving a user input for selecting a second fermentation level through the control panel.

6. The refrigerator of claim 1, wherein the processor is configured to:
control the heater to maintain the temperature in the case at the first temperature for the first time period based on receiving a user input for selecting a first fermentation level through the control panel; and
control the heater to maintain the temperature in the case at the first temperature for a third time period longer than the first time period based on receiving a user input for selecting a second fermentation level through the control panel.

7. The refrigerator of claim 1, wherein the processor is configured to:
control the heater to maintain the temperature in the case at the first temperature for the first time period based on receiving a user input for selecting a first fermentation level through the control panel; and
control the heater to maintain the temperature in the case at a third temperature higher than the first temperature for a third time period longer than the first time period based on receiving a user input for selecting a second fermentation level through the control panel.

8. The refrigerator of claim 1, wherein the processor is configured to set at least one of a fermentation time or a fermentation temperature based on a remaining time until consumed by a user, based on receiving a user input for the remaining time until consumed by the user through the control panel.

9. The refrigerator of claim 8, wherein the processor is configured to control the heater to maintain the temperature in the case at the first temperature for a first time period, based on the remaining time until consumed by the user being greater than or equal to the first time period.

10. The refrigerator of claim 8, wherein the processor is configured to control the heater to maintain the temperature in the case at the fermentation temperature for the remaining time until consumed by the user, based on the remaining time until consumed by the user being less than the first time period.

11. The refrigerator of claim 8, wherein the processor is configured to control the heater to maintain the temperature in the case at a target temperature that depends on the remaining time until consumed by the user, based on the remaining time until consumed by the user being less than the first time period.

12. A method for controlling a refrigerator including a case arranged in a storage compartment, a heater arranged in the case, and a fan configured to introduce air from outside the case into the case, the method comprising:
controlling the heater to maintain a temperature in the case at a fermentation temperature for a fermentation time based on receiving a user input through a control panel of the refrigerator; and
controlling the fan to introduce air in the storage compartment into the case based on the fermentation time having elapsed,
wherein the controlling of the heater comprises:
controlling the heater based on receiving a user input for a normal fermentation via the control panel to maintain the temperature in the case at a first temperature for a first time period; and
controlling the heater based on receiving a user input for a rapid fermentation via the control panel to maintain the temperature in the case at a second temperature higher than the first temperature for a second time period shorter than the first time period

13. The method of claim 12, further comprising:
receiving a user input for fermented food via the control panel; and
controlling the heater to maintain the temperature in the case at different temperatures based on user inputs for different fermented foods.

14. The method of claim 12, further comprising:
receiving a user input for fermented food via the control panel; and
controlling the heater to maintain the temperature in the case at the fermentation temperature for different time periods based on user inputs for different fermented foods.

15. The method of claim 12, further comprising:
controlling the heater to maintain the temperature in the case at the first temperature, based on receiving a user input for selecting a first fermentation level through the control panel; and
controlling the heater to maintain the temperature in the case at a third temperature higher than the first temperature, based on receiving a user input for selecting a second fermentation level through the control panel.
